(19) United States
(12) Patent Application Publication
(10) Pub. No.: US 2025/0377272 A1
(43) Pub. Date: Dec. 11, 2025

(54) IMPURITY ACQUISITION SYSTEM, QUALITY INSPECTION SYSTEM, AND LIQUID PRODUCTION AND SUPPLY SYSTEM

(71) Applicants: ORGANO CORPORATION, Tokyo (JP); IAS Inc., Tokyo (JP)

(72) Inventors: Kyohei TSUTANO, Tokyo (JP); Ayumi TEZUKA, Tokyo (JP); Akihiko TSUDA, Tokyo (JP); Tatsuya ICHINOSE, Tokyo (JP); Hironobu KONO, Tokyo (JP); Shuhei MATSUSHITA, Tokyo (JP)

(73) Assignees: ORGANO CORPORATION, Tokyo (JP); IAS Inc., Tokyo (JP)

(21) Appl. No.: 19/103,416

(22) PCT Filed: Aug. 4, 2023
(86) PCT No.: PCT/JP2023/028566

§ 371 Date: Feb. 12, 2025

(30) Foreign Application Priority Data
Aug. 17, 2022 (JP) 2022-129978

(51) Int. Cl. G01N 1/40; G01N 1/34; G01N 30/96

(52) U.S. Cl. CPC G01N 1/405; G01N 1/34; G01N 1/4005; G01N 30/96; G01N 2001/4011

(57) ABSTRACT

An impurity acquisition system includes: an enrichment column that adsorbs impurities in a liquid being tested and a control unit that is used to switch between an enrichment process in which the liquid being tested is passed through the enrichment column, an eluent filling process in which a filling container is filled with a predetermined amount of eluent that elutes impurities adsorbed in the enrichment column, and an elution and collection process in which the eluent is passed through the enrichment column and collected in a collection container.

### TECHNICAL FIELD

This invention relates to an impurity acquisition system, a quality inspection system, and a liquid production and supply system.

### BACKGROUND OF ART

In general, one method of testing the quality of ultrapure water supplied from ultrapure water production facilities to a point of use (e.g., a point of use in semiconductor cleaning equipment) is to use analysis by a pretreatment method that uses ion exchangers. As an analysis method that has been considered to be such a pretreatment method, the quality of ultrapure water is tested by passing ultrapure water through an ion exchanger for a predetermined period, followed by removing and retrieving the ion exchanger, eluting impurities from the retrieved ion exchanger using an eluent, and measuring their concentration in the eluent (e.g., see Patent Document 1).

### PRIOR ART DOCUMENTS

### Patent Documents

Patent Document 1: JP 2001-153854 A

### SUMMARY OF THE INVENTION

### Problem to be Solved by the Invention

In the technology described above, the ion exchanger must be removed to test the quality of ultrapure water. This time-consuming process makes it difficult to conduct efficient inspections.

The purpose of the present invention is to provide an impurity acquisition system, a quality inspection system, and a liquid production and supply system that enables efficient inspection of the quality of liquids.

### Means for Solving the Problem

An impurity acquisition system of the present invention is the impurity acquisition system for acquiring impurities in a liquid to be tested, comprising: a first adsorbent that adsorbs impurities in the liquid to be tested; and a first controller that switches between an enrichment process in which the liquid to be tested is passed through the first adsorbent, an eluent filling process in which a filling container is filled with a predetermined amount of eluent to elute impurities adsorbed on the first adsorbent, and an elution and collection process in which the eluent in the filling container is passed through the first adsorbent and collected in a collection container.

Also, a quality inspection system of the present invention is the quality inspection system, comprising:
an impurity acquisition system comprises a first adsorbent that adsorbs impurities in the liquid to be tested; and a first controller that switches between an enrichment process in which the liquid to be tested is passed through the first adsorbent, an eluent filling process in which a filling container is filled with a predetermined amount of eluent to elute impurities adsorbed on the first adsorbent, and an elution and collection process in which the eluent in the filling container is passed through the first adsorbent and collected in a collection container;
an information processing device that detects the amount of impurities in collected elution liquid that has passed through the first adsorbent; and
an arithmetic processor that calculates the amount of impurities in the liquid being tested.

Also, a liquid production and supply system of the present invention is the liquid production and supply system, comprising:
a quality inspection system comprises an impurity acquisition system comprises a first adsorbent that adsorbs impurities in the liquid to be tested; and
a first controller that switches between an enrichment process in which the liquid to be tested is passed through the first adsorbent, an eluent filling process in which a filling container is filled with a predetermined amount of eluent to elute impurities adsorbed on the first adsorbent, and an elution and collection process in which the eluent in the filling container is passed through the first adsorbent and collected in a collection container, an information processing device that detects the amount of impurities in collected elution liquid that has passed through the first adsorbent, and an arithmetic processor that calculates the amount of impurities in the liquid being tested;
a valve section that controls supply of the liquid to be tested from the liquid production and supply facility that performs at least one of the production and supply of the liquid to be tested to a point of use where the liquid to be tested is used; and
a second controller that controls the valve section based on the amount of impurities in the liquid being tested as calculated by the arithmetic processor.

### Advantageous Effects of the Invention

In this invention, the quality of liquids can be efficiently inspected.

### BRIEF DESCRIPTION OF THE DRAWINGS

FIG. 1 is a diagram showing a first embodiment of an impurity acquisition system of the present invention.

FIG. 2 is a flowchart illustrating an example of an impurity acquisition method in the impurity acquisition system shown in FIG. 1.

FIG. 3 is a flowchart illustrating an example of the procedures of the enrichment process of Step S1 in the flowchart shown in FIG. 2.

FIG. 4 is a flowchart illustrating an example of the procedures of the purging process of Step S2 in the flowchart shown in FIG. 2.

FIG. 5 is a flowchart illustrating an example of the procedures of the eluent filling process of Step S3 in the flowchart shown in FIG. 2.

FIG. 6 is a flowchart illustrating an example of the procedures of the elution and collection process of Step S4 in the flowchart shown in FIG. 2.

FIG. 7 is a flowchart illustrating an example of the procedures of the cleaning process of Step S5 in the flowchart shown in FIG. 2.

FIG. 8 is a diagram showing a second embodiment of an impurity acquisition system of the present invention.

FIG. 9 is a flowchart illustrating an example of an impurity acquisition method in the impurity acquisition system shown in FIG. 8.

FIG. 10 is a flowchart illustrating an example of the procedures of the regeneration liquid filling process of Step S26 in the flowchart shown in FIG. 9.

FIG. 11 is a flowchart illustrating an example of the procedures of the regeneration process of Step S27 in the flowchart shown in FIG. 9.

FIG. 12 is a diagram showing a third embodiment of an impurity acquisition system of the present invention.

FIG. 13 is a time chart illustrating an example of the intersystem timing control performed by controller shown in FIG. 12.

FIG. 14 is a diagram showing an example of a liquid production and supply system to which the impurity acquisition system of the present invention is applied.

FIG. 15 is a flowchart illustrating an example of the procedures in the system shown in FIG. 14.

FIG. 16 is a diagram showing another example of a liquid production and supply system to which the impurity acquisition system of the present invention is applied.

### DESCRIPTION OF THE EMBODIMENTS

Embodiments of the invention are next described with reference to the drawings. Here, we will use an example in which the liquid to be tested is ultrapure water.

### First Embodiment

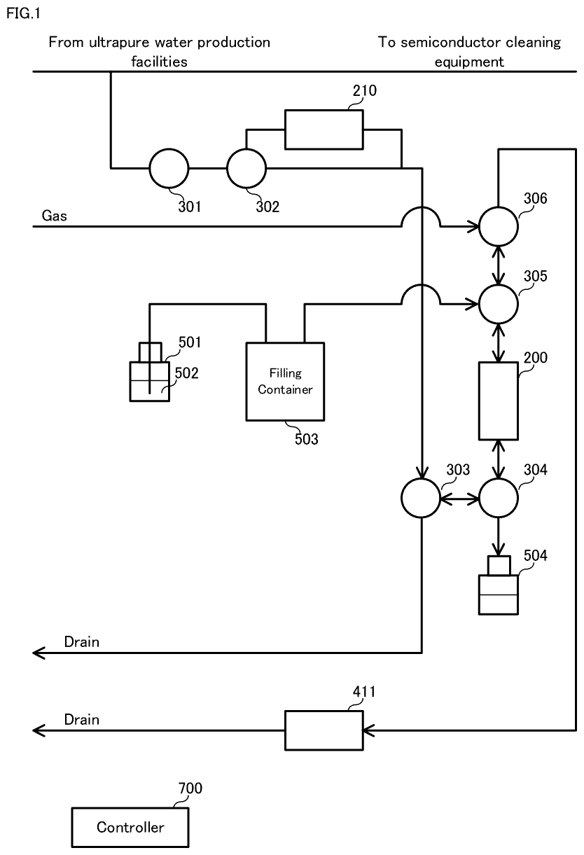

FIG. 1 is a diagram showing the first embodiment of an impurity acquisition system of the present invention. As shown in FIG. 1, the impurity acquisition system in this embodiment has enrichment column (ion exchanger unit) 200 as the first adsorbent, guard column 210 as the second adsorbent, valves 301 to 306 as valves, accumulated flow rate meter 411, container 501 in which eluent 502 is stored, filling container 503, collection container 504, and controller 700.

Enrichment column 200 is a unit that adsorbs impurities from the liquid to be tested from an ultrapure water production facility. Here, the ultrapure water production facility, for example, produces ultrapure water to be supplied to semiconductor cleaning equipment, which is the point of use, and supplies the ultrapure water. In the following description, this ultrapure water is the liquid that is the object of inspection (liquid to be tested), and the liquid to be tested is ultrapure water supplied from an ultrapure water production facility. Enrichment column 200 can be made of any material that has ion removal or ion adsorption capabilities. An example of enrichment column 200 is an ion adsorption membrane or monolithic organic porous ion-exchange resin. The object to be removed or adsorbed by enrichment column 200 is impurities. These impurities include ions (ionic metal impurities) and particulate forms. In this embodiment, the functional group of enrichment column 200 is a cation exchange group, an anion exchange group, or a chelate compound.

As the pretreatment method using enrichment column 200 of the present invention, for example, a pretreatment method using a monolithic organic porous is used. Examples of monolithic organic porous structure used here include the continuous bubble structure disclosed in JP 2002-306976 A and JP 2009-62512 A, the co-continuous structure disclosed in JP 2009-67982 A, the particle agglomerated structure disclosed in JP 2009-7550 A, and the particle composite structure disclosed in JP 2009-108294 A. The structure, materials, and properties of the ion exchanger are also as disclosed in JP 2019-195763 A. In addition, examples that can be offered as ion exchange groups introduced into a monolithic organic porous substance, cation exchange groups introduced in monolithic organic porous cation exchangers, and anion exchange groups introduced in monolithic organic porous anion exchangers are disclosed in JP 2019-195763 A.

Guard column 210 is a material that adsorbs impurities from the liquid to be tested from ultrapure water production facilities. Guard column 210 need only be capable of adsorbing and removing impurities from the liquid to be tested and, for example, can be the same as enrichment column 200.

Valve 301 is a shutoff valve that controls the flow of liquid to be tested from the ultrapure water production facility or the flow of liquid used for cleaning into the impurity acquisition system. Valve 301 is an acquisition means used to acquire the liquid to be tested from the path from the ultrapure water production facility to the semiconductor cleaning equipment. Valve 302 is a valve that controls whether the liquid (liquid to be tested or liquid used for cleaning) from valve 301 passes through or does not pass through guard column 210 as a route to valve 303. Valve 303 is a valve that controls the passage of liquid from valve 302 to either valve 304 or the drainage path, as well as of liquid from valve 304 to the drainage path. Valve 304 is a valve that controls whether liquid from valve 303 is passed through to enrichment column 200 or whether eluent from enrichment column 200 is passed through to collection container 504. Valve 305 is a valve that controls the passage to enrichment column 200 of either liquid (eluent) from filling container 503 or gas from valve 306, and further, the passage of liquid from enrichment column 200 to valve 306. Valve 306 is a valve that controls the passage of liquid from valve 305 to the drainage path on which accumulated flow rate meter 411 is provided, or the discharge to valve 305 of gas (e.g., nitrogen) supplied in the purging process or the liquid that is pushed by this gas. These valves open and close to select routes according to control signals from controller 700. As an example, three-way valves are used as valves 302 to 306.

Eluent 502 is an acidic or alkaline aqueous solution that elutes impurities concentrated in enrichment column 200. Examples of eluent 502 include acidic aqueous solutions such as nitric acid, hydrochloric acid, and sulfuric acid, or alkaline aqueous solutions of organic alkalis such as tetramethylammonium hydroxide (TMAH). Eluent 502 is an aqueous solution with a metal impurity concentration of less than 100 ng/L. No particular limitations apply to the dilution of eluent 502. Eluent 502 may be diluted with the water to be tested that is the object of measurement.

Eluent containing impurities eluted from enrichment column 200 in the elution and collection process flows through valve 304 and into collection container 504. An example of collection container 504 is a collection bottle. Collection container 504 is not limited as long as it can collect the eluent. Filling container 503 is a container used in the elution and collection process. Filling container 503 is filled with a predetermined amount of eluent. The filling container can be any structure that can be filled with liquid. Filling containers 503 include, for example, tubes, bottles, and tanks. Filling container 503 that is a tube may have a looped shape. Filling container 503 can be a container made of a resin material having low elution of metal impurities. Filling container 503 is preferably made of fluorine-based materials such as PFA, PTFE, and PVDF. Forming filling container 503 as a tube allows connection directly to components that precede or follow filling container 503, whereby the number of parts can be reduced. The method for filling this filling container 503 with a predetermined amount of eluent can include pumping eluent 502 from container 501 using gas pressure or a pump. Whether or not a predetermined amount of eluent fills filling container 503 may be determined by, for example, using a measuring device to measure the amount of eluent in filling container 503, a sensor to detect infill of a predetermined amount, or a gravimeter to measure the weight of the predetermined amount of eluent. accumulated flow rate meter 411 measures the flow rate of the liquid being discharged as wastewater. The values measured by accumulated flow rate meter 411 are reported to controller 700. A predetermined signal may be used for this report. This signal may be transmitted by accumulated flow rate meter 411 and received by controller 700.

Controller 700 is a first controller that controls the opening and closing of each of valves 301 to 306 and the start and end of infill to filling container 503 of eluent 502 based on a preset time. The elapse of this predetermined period may be determined based on whether a predetermined time period has elapsed. Controller 700 may also control the opening and closing of each of valves 301 to 306 based on whether the amount of liquid (liquid to be tested) measured by accumulated flow rate meter 411 has reached a preset value (threshold value). Controller 700 may also control the start and end of the filling of filling container 503 with eluent 502 by controlling gas pressure or pumps based on the detection results of the sensors and weight scales described above.

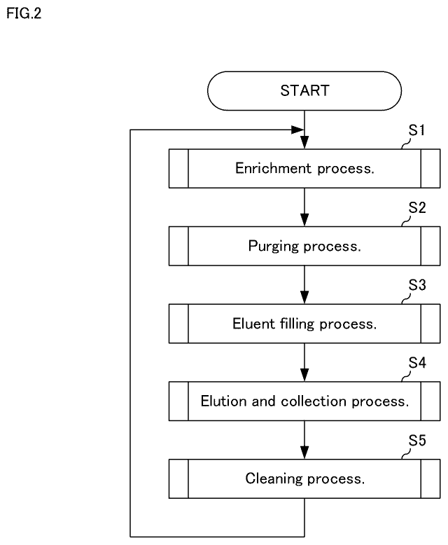

The impurity acquisition method in the impurity acquisition system shown in FIG. 1 is next described. In this impurity acquisition method, controller 700 controls each of valves 301 to 306. FIG. 2 is a flowchart illustrating an example of the impurity acquisition method in the impurity acquisition system shown in FIG. 1.

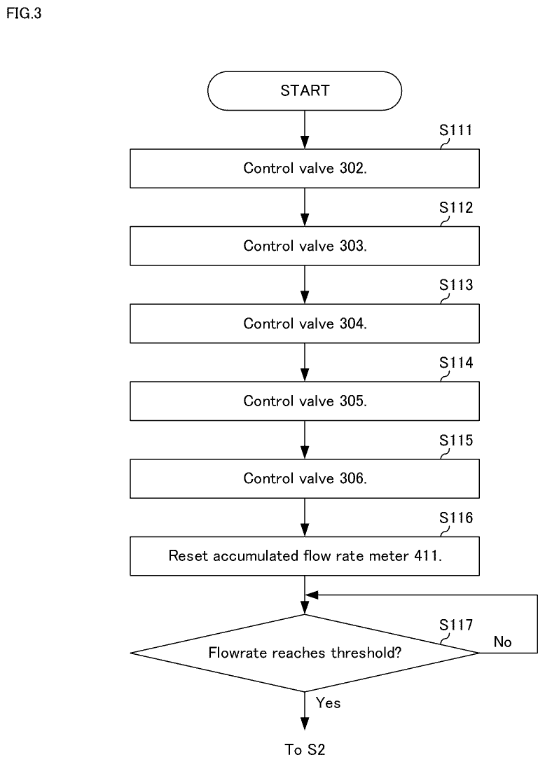

First, controller 700 executes an enrichment process (Step S1). FIG. 3 is a flowchart illustrating an example of the procedures of the enrichment process of Step S1 in the flowchart shown in FIG. 2. Controller 700 controls valve 302 so that the liquid to be tested from valve 301 flows into the path to valve 303 without passing through guard column 210 (Step S111). Controller 700 controls valve 303 so that the liquid to be tested from valve 302 flows into the path to valve 304 (Step S112). Controller 700 controls valve 304 so that the liquid to be tested from valve 303 is passed through to enrichment column 200 (Step S113). Controller 700 controls valve 305 so that the liquid being tested that has passed through enrichment column 200 flows into the path to valve 306 (Step S114). Controller 700 controls valve 306 so that the liquid being tested from valve 305 flows into the drainage path through accumulated flow rate meter 411 (Step S115). Once the control of Steps S111 to S115 is completed, a path is established through valve 301, valve 302, valve 303, valve 304, enrichment column 200, valve 305, valve 306, and accumulated flow rate meter 411. Here, controller 700 controls the open/closed state of valve 301 to temporarily close valve 301 so that the liquid to be tested from the ultrapure water production facility does not flow into this system. Controller 700 then resets accumulated flow rate meter 411 (Step S116). Controller 700 then controls the open/closed state of valve 301 to open valve 301 so that the liquid to be tested from the ultrapure water production facility flows into this system. Controller 700 then determines whether the value of the flow rate measured by accumulated flow rate meter 411 has reached the predetermined threshold value (Step S117). When the value of the flow rate measured by accumulated flow rate meter 411 reaches the predetermined threshold value, controller 700 performs the process of Step S2.

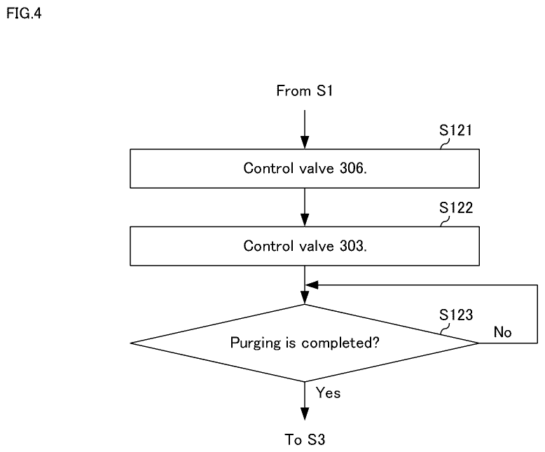

Controller 700 next executes a purging process (Step S2). In the purging process, gas is caused to flow through pipes (paths) to flush out, for example, impurities and water remaining in the pipes. FIG. 4 is a flowchart illustrating an example of the procedures of the purging process of Step S2 in the flowchart shown in FIG. 2. Controller 700 controls valve 306 so that externally supplied gas (e.g., nitrogen) is fed into the path to valve 305 (Step S121). The type of gas used here includes inert gas, air (from the atmosphere), and oxygen. Inert gases include rare gases such as nitrogen gas, argon gas, and helium gas. The purity of the gas is preferably 99.9% or higher, and more preferably 99.99% or higher, the lowest possible impurity content in the gas being preferred. Impurities in high-purity gas include methane, oxygen, carbon dioxide, and moisture when the gas is an inert gas, and particulates and moisture when the gas is air or oxygen. Controller 700 controls valve 303 so that the gas from valve 304 and the liquid pushed out by the gas are discharged into the drainage path (Step S122). Once the controls of Steps S121 and S122 are completed, a path is established through valve 306, valve 305, enrichment column 200, valve 304, and valve 303. Gas is then injected to purge the system. Controller 700 then determines whether purging is complete (Step S123). This determination can be based on the time elapsed from the start of the purge when valve 306, valve 305, valve 304, and valve 303, having been closed, are opened to open the paths, or can be based on the amount of gas injected after the paths were opened. When purging is complete, controller 700 performs the process of Step S3.

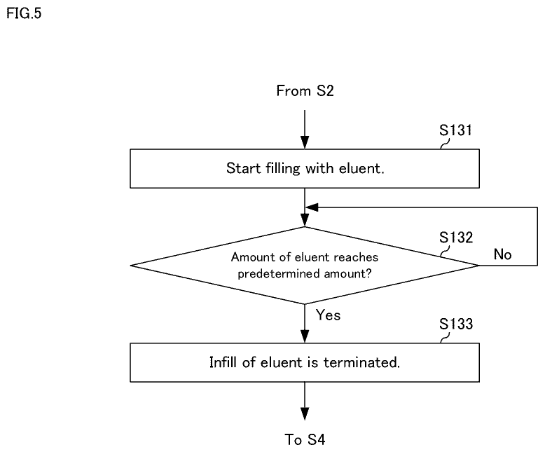

Controller 700 next executes an eluent filling process (Step S3). FIG. 5 is a flowchart illustrating an example of the procedures of the eluent filling process of Step S3 in the flowchart shown in FIG. 2. Controller 700 starts to fill filling container 503 with eluent 502 stored in container 501 (Step S131). For example, controller 700 pumps eluent 502 from container 501 to filling container 503 using gas pressure or a pump. Controller 700 then determines whether the amount of eluent 502 in filling container 503 has reached the predetermined amount (Step S132). This determination may be based on the detection results of the sensors previously described or the measurement results of a weight scale. When controller 700 determines that the amount of eluent 502 in filling container 503 has reached the predetermined amount, the infill of filling container 503 with eluent is terminated (Step S133) and the process of Step S4 is performed.

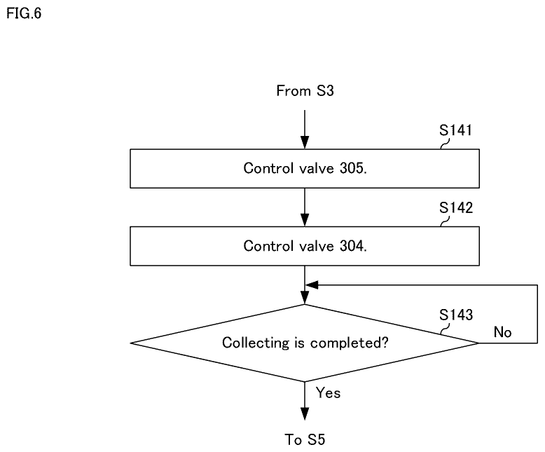

Controller 700 next executes an elution and collection process (Step S4). FIG. 6 is a flowchart illustrating an example of the procedures of the elution and collection process of Step S4 in the flowchart shown in FIG. 2. In this process, impurities in enrichment column 200 are eluted using a predetermined amount of the eluent used to fill filling container 503 in the eluent filling process in Step S3. Controller 700 controls valve 305 so that the eluent in filling container 503 is passed through to enrichment column 200 (Step S141). At this time, controller 700 controls eluent 502 stored in container 501 so that it is not supplied to filling container 503. For example, a shutoff valve may be provided between container 501 and filling container 503, and controller 700 may control the open/closed state of the valve to close the valve. Controller 700 controls valve 304 so that the eluent that has passed through enrichment column 200 is collected in collection container 504 (Step S142). Once the control of Steps S141 and S142 is completed, a path is established from filling container 503 to collection container 504 via valve 305, enrichment column 200, and valve 304. Controller 700 pumps eluent from filling container 503 to collection container 504 using, for example, gas pressure or a pump. When controller 700 completes collection of the eluent in collection container 504 (Step S143), the process of Step S5 is performed. To determine whether the collection of eluent in collection container 504 is complete, controller 700 may, for example, determine that the collection of eluent in collection container 504 is complete by using a sensor or the like to detect that the supply of eluent from filling container 503 has ceased. The direction in which the eluent is passed through enrichment column 200 in this elution and collection process is opposite to the direction in which the liquid to be tested is passed through enrichment column 200 in the enrichment process. The amount (including concentration) of impurities contained in the liquid being tested that passed through enrichment column 200 in the enrichment process decreases in the direction of flow. Therefore, by passing the eluent in the direction opposite to the direction in which the liquid to be tested passed through enrichment column 200 in the enrichment process, a higher recovery rate can be obtained using a smaller amount of eluent.

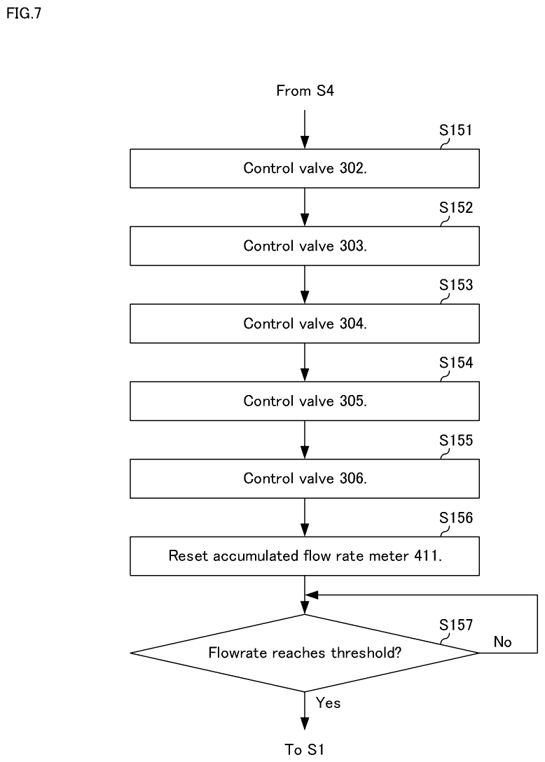

Controller 700 next executes a cleaning process (Step S5). FIG. 7 is a flowchart illustrating an example of the procedures of the cleaning process of Step S5 in the flowchart shown in FIG. 2. Controller 700 controls valve 302 so that the liquid to be tested from valve 301 flows to guard column 210 (Step S151). Controller 700 controls valve 303 so that the liquid to be tested from guard column 210 flows into the path to valve 304 (Step S152). Controller 700 controls valve 304 so that the liquid to be tested from valve 303 passes through to enrichment column 200 (Step S153). Controller 700 controls valve 305 so that the liquid to be tested that has passed through enrichment column 200 flows into the path to valve 306 (Step S154). Controller 700 controls valve 306 so that the liquid to be tested from valve 305 is discharged into the drainage path via accumulated flow rate meter 411 (Step S155). Once the control of Steps S151 to S155 is completed, a path is established through valve 301, valve 302, guard column 210, valve 303, valve 304, enrichment column 200, valve 305, valve 306, and accumulated flow rate meter 411. Here, controller 700 controls the open/closed state of valve 301 to temporarily close valve 301 so that liquid to be tested from the ultrapure water production facility does not flow into this system. Controller 700 then resets accumulated flow rate meter 411 (Step S156). Controller 700 next controls the open/closed state of valve 301 to open valve 301 so that liquid to be tested from the ultrapure water production facility flows into this system. Controller 700 then determines whether the value of the flow rate measured by accumulated flow rate meter 411 has reached the predetermined threshold value (Step S157). When the value of the flow rate measured by accumulated flow rate meter 411 reaches the predetermined threshold value, controller 700 performs the process of Step S1.

Thus, in this embodiment, controlling valves or pumps, etc. installed at key points in the flow path upon the passage of each of predetermined periods of time brings about transitions between the procedures of an enrichment process in which impurities in the liquid being tested are captured using enrichment column 200, an elution and collection process in which the captured impurities are eluted from enrichment column 200 and collected, and a cleaning process in which enrichment column 200 from which the impurities have been eluted is cleaned with the liquid being tested. This process allows a sample to be obtained for testing the quality of the water being tested without removing enrichment column 200 from the system. As a result, efficient testing of the quality of the water being tested can be performed. Removing enrichment column 200 from the system before the elution and collection process is performed may cause enrichment column 200 to become contaminated when it is removed or when it is installed in the equipment for elution, resulting in a loss of test accuracy. In this embodiment, the elution and collection process can be performed repeatedly without removing enrichment column 200 from the system. Therefore, enrichment column 200 will not be contaminated and the test accuracy can be maintained. Furthermore, the eluent used in the elution and collection process is used in a predetermined amount and collected in a container for analysis. A continuous analysis method is the flow injection method (FIA method), in which the eluent is introduced directly into the detector (analyzer). In the FIA method, impurity concentration is calculated using the peak area derived from the retention time and change. In the FIA method, the retention time differs for each impurity. Therefore, it is necessary to select an eluent for each impurity to be detected and to change the measurement mode of the detector depending on the impurity. This requirement complicates the simultaneous detection of multiple impurities from the eluent obtained in one process. On the other hand, in this embodiment, a certain amount of eluent is used and impurities are detected after collection in a container. Therefore, this embodiment enables simultaneous detection of multiple impurities from the eluent obtained in one process and thus solves the problem of the FIA method described above. Controller 700 may perform only one of either the purging process or the eluent filling process. In the eluent filling process, controller 700 may fill a component other than filling container 503 with eluent. In this case, controller 700 collects the eluent contained in that component in the elution and collection process. Before the enrichment process, controller 700 may perform a line cleaning process to clean the path through valve 301, valve 302, guard column 210, and valve 303. The line cleaning process can drain water accumulated in the piping between the ultrapure water production facility and the impurity acquisition system. The process can therefore transition to the enrichment process in a state in which water is flowing from the ultrapure water production facility.

### Second Embodiment

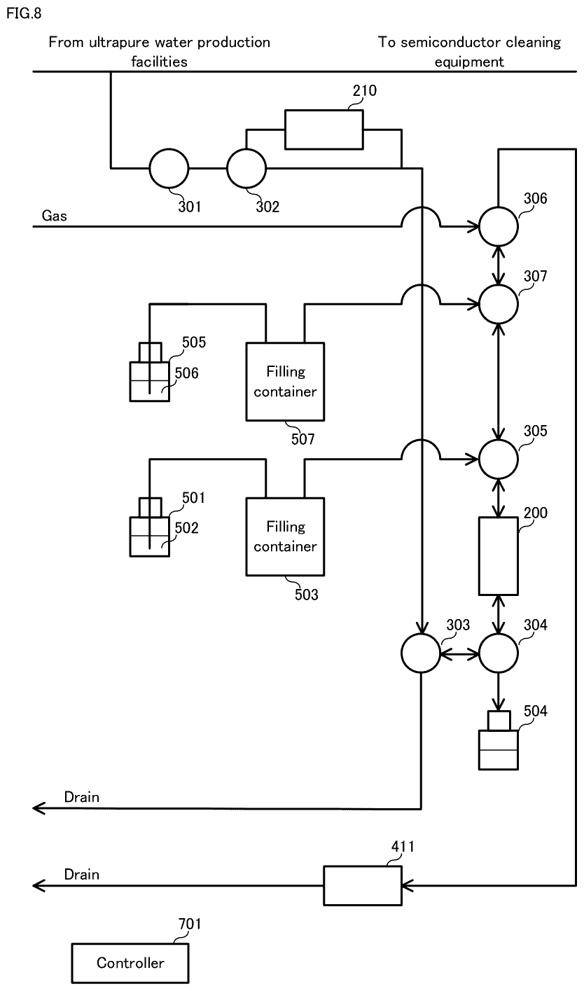

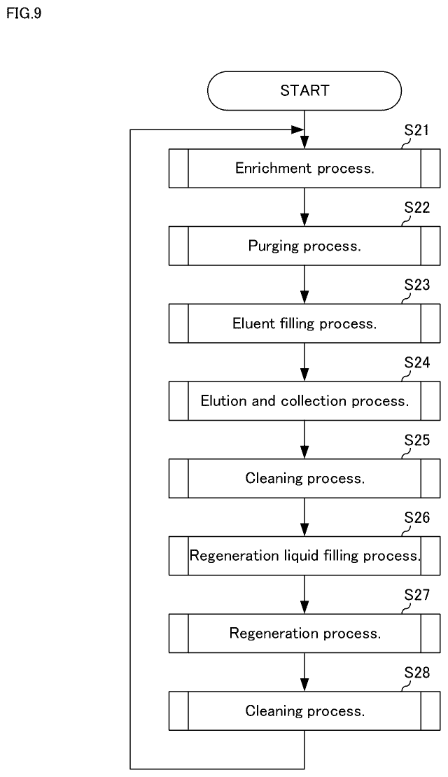

FIG. 8 is a diagram showing the second embodiment of an impurity acquisition system of the present invention. As shown in FIG. 9, the impurity acquisition system in this embodiment has, in addition to the components in the embodiment shown in FIG. 1, valve 307, container 505 in which regeneration liquid 506 is stored, and filling container 507. As shown in FIG. 9, the impurity acquisition system in this embodiment has controller 701 instead of controller 700 in the embodiment shown in FIG. 1.

Regeneration liquid 506 is an acidic or alkaline liquid used to regenerate enrichment column 200 in a regeneration process that follows eluting and washing the impurities concentrated in enrichment column 200. Regeneration liquid 506 is placed in a bottle or other container similar to container 505. The concentration of metal impurities in regeneration liquid 506 is less than 100 ng/L.

Filling container 507 is a container filled with a predetermined amount of regeneration liquid to be used in the regeneration process. The material of filling container 507 may be the same as the material of filling container 503. The method of filling this filling container 507 with a predetermined amount of regeneration liquid can be done by using gas pressure or a pump to pump regeneration liquid 506 from container 505. The determination of whether filling container 507 is filled with a predetermined amount of the regeneration liquid can be achieved by using, for example, a measuring device to measure the amount of regeneration liquid in filling container 507, a sensor to detect that a predetermined amount is in filling container 507, or a gravimeter to measure the weight of a predetermined amount of regeneration liquid.

Valve 307 is a valve that effects control such that either the gas from valve 306 or the liquid (regeneration liquid) fed from filling container 507 is passed to enrichment column 200, or such that the liquid from enrichment column 200 is passed to valve 306 by way of valve 305. Valve 307 opens, closes, or selects a path according to control signals from controller 701. As an example, a three-way valve is used as valve 307.

Controller 701 is a first controller that controls the opening and closing of each of valves 301 to 307 as well as the start and end of the infill of filling containers 503 and 507 with eluent 502 and regeneration liquid 506, respectively, based on preset times. Controller 701 may control the opening and closing of each of valves 301 to 307 based on whether the amount of liquid (liquid being tested) measured by accumulated flow rate meter 411 has reached a preset value (threshold value). Controller 701 may also control the start and end of the filling processes for eluent 502 and regeneration liquid 506 by controlling gas pumping or pumps based on the detection results of the previously described sensors and weight scales.

The impurity acquisition method in the impurity acquisition system shown in FIG. 8 is next described. In this impurity acquisition method, controller 701 controls each of valves 301 to 307. FIG. 9 is a flowchart illustrating an example of the impurity acquisition method in the impurity acquisition system shown in FIG. 8.

Controller 701 first executes an enrichment process (Step S21). This process is the same as the enrichment process in the first embodiment. Controller 701 then executes a purging process (Step S22). This process is the same as the purging process in the first embodiment. Next, controller 701 executes an eluent filling process (Step S23) by the same process as described for the eluent filling process in the first embodiment. Controller 701 next executes an elution and collection process (Step S24), again by the same process as described for the elution and collection process in the first embodiment. Controller 701 then executes a cleaning process (first cleaning process) (Step S25). This process is again the same as the cleaning process in the first embodiment.

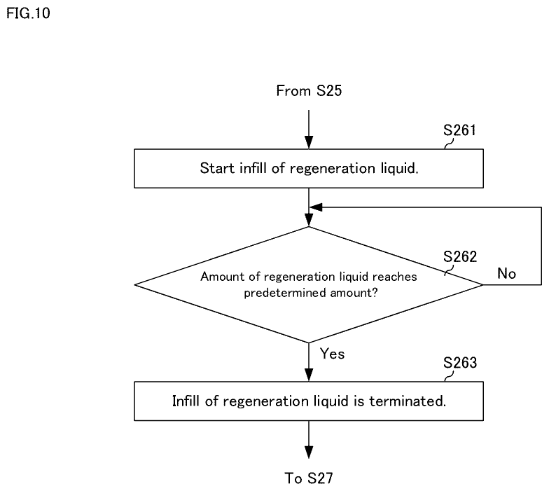

Controller 701 then executes a regeneration liquid filling process (Step S26). FIG. 10 is a flowchart illustrating an example of the procedures of the regeneration liquid filling process of Step S26 in the flowchart shown in FIG. 9. Controller 701 starts the infill of filling container 507 with regeneration liquid 506 stored in container 505 (Step S261). For example, controller 701 pumps regeneration liquid 506 from container 505 to filling container 507 using gas pressure or a pump. Controller 701 then determines whether the amount of regeneration liquid 506 in filling container 507 has reached a predetermined amount (Step S262). This determination may be carried out based on the detection results of the previously described sensors or the measurement results of a weight scale. Upon determining that the amount of regeneration liquid 506 in filling container 507 has reached the predetermined amount, controller 701 terminates the transfer of the regeneration liquid (Step S263) and performs the process of Step S27.

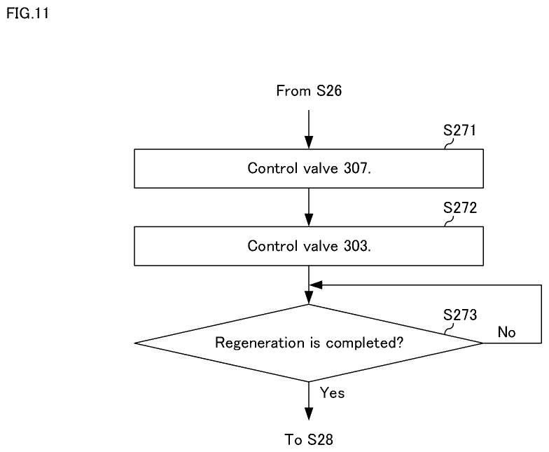

Controller 701 next executes a regeneration process (Step S27). FIG. 11 is a flowchart illustrating an example of the procedures of the regeneration process of Step S27 in the flowchart shown in FIG. 9. In this process, enrichment column 200 is regenerated using a predetermined amount of regeneration liquid that was transferred to filling container 507 in the regeneration liquid filling process of Step S26. Controller 701 controls valve 307 so that the regeneration liquid in filling container 507 passes through valve 307 to enrichment column 200 (Step S271). At this time, controller 701 effects control such that regeneration liquid 506 stored in container 505 is not supplied to filling container 507. For example, a shutoff valve may be provided between container 505 and filling container 507, and controller 701 may control the open/closed state of the valve to the closed state. Controller 701 controls valve 303 so that regeneration liquid from valve 304 is discharged into the drainage path (Step S272). Once the control of Steps S271 and S272 is completed, a path is established for the regeneration liquid to pass through and thus drain from filling container 507 through valve 307, valve 305, enrichment column 200, valve 304, and valve 303. Controller 701 pumps the regeneration liquid from filling container 507 to enrichment column 200 using, for example, gas pressure or a pump. Upon completing the pumping of the regeneration liquid that was in filling container 507 (Step S273), controller 701 performs the process of Step S28. Controller 701 may determine that the pumping of the regeneration liquid in filling container 507 is complete by using a sensor or the like to detect that the supply of the regeneration liquid from filling container 507 is no longer available. The direction in which the regeneration liquid is passed through enrichment column 200 in the regeneration process is opposite to the direction in which the liquid being tested was passed through enrichment column 200 in the enrichment process.

Controller 701 next executes a cleaning process (second cleaning process) (Step S28). This process is the same as the cleaning process in Step S25. After the process of Step S28 is completed, controller 701 performs the process of Step S21.

Thus, in this embodiment, the control of components such as valves and pumps installed at key locations along flow paths at each of elapsed periods causes the transitions of an enrichment process in which impurities in the liquid being tested are captured using enrichment column 200, an elution and collection process in which the captured impurities are eluted from enrichment column 200 and collected, and a cleaning process in which enrichment column 200 from which the impurities have been eluted is cleaned with the liquid being tested. This configuration allows a sample to be obtained for testing the quality of the water being tested without removing enrichment column 200 from the system. As a result, efficient testing of the quality of the water being tested can be performed. If the elution and collection process is performed after enrichment column 200 is removed from the system, enrichment column 200 may become contaminated when enrichment column 200 is removed or when it is attached to the equipment for elution, and this contamination could reduce the accuracy of the inspection. In this embodiment, the elution and collection process can be performed without removing the enrichment column 200 from the system. As a result, enrichment column 200 is not contaminated and the accuracy of the inspection can be maintained. In addition, a predetermined amount of eluent is used in the elution and collection process. Performing the analysis after a fixed amount is collected ensures that the concentration of impurities in the eluent will be uniform and unchanged over time and that accurate values can be obtained. Controller 701 may perform only one of either the purging process or the eluent filling process. In the eluent filling process, controller 701 may fill components other than filling container 503 with eluent. In this case, controller 701 collects the eluent in that component in the elution and collection process. In addition, because controller 701 uses a predetermined amount of regeneration liquid for the regeneration process, the regeneration liquid can be used without waste in the regeneration process. The usual procedure of removing, regenerating, and then re-installing enrichment column 200 introduces the risk of contaminating enrichment column 200 during the processes of removing or re-installing in the equipment for regenerating enrichment column 200, thereby reducing inspection accuracy. In this embodiment, the regeneration process can be performed repeatedly without removing enrichment columns 200 from the system. This embodiment therefore both saves the time required for removal and installation and prevents contamination of enrichment column 200 that would reduce inspection accuracy.

### Third Embodiment

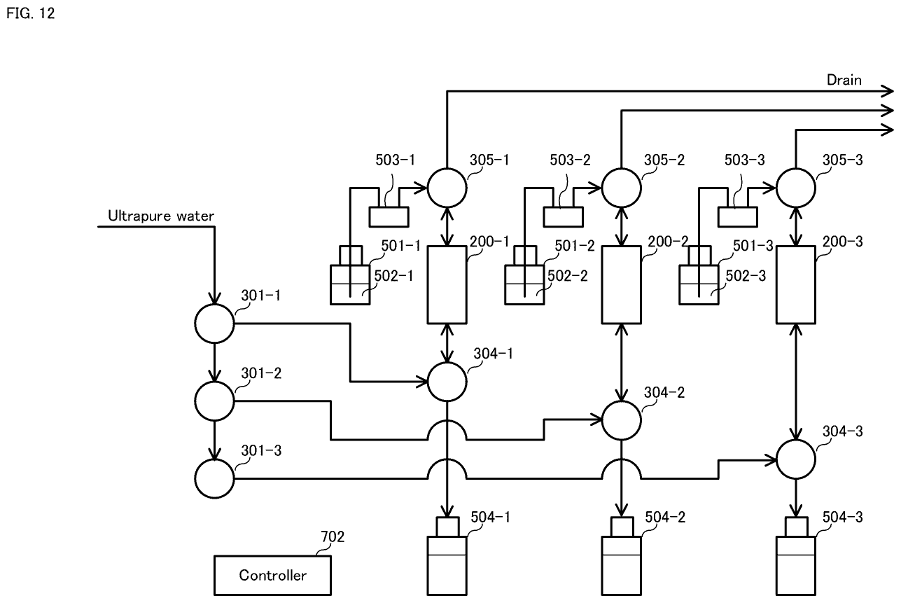

FIG. 12 is a diagram showing a third embodiment of the impurity acquisition system of the present invention. As shown in FIG. 12, the impurity acquisition system in this embodiment includes enrichment columns 200-1 to 200-3; valves 301-1 to 301-3, 304-1 to 304-3, and 305-1 to 305-3; containers 501-1 to 501-3 in which eluents 502-1 to 502-3, respectively, are stored; filling containers 503-1 to 503-3; collection containers 504-1 to 504-3; and controller 702. In other words, the impurity acquisition system in this embodiment is an embodiment with three parallel systems which have the components of the impurity acquisition system of the first embodiment. In FIG. 12, other valves and flowmeters in the first embodiment are omitted for convenience of illustration. Enrichment columns 200-1 to 200-3 each correspond to enrichment column 200. Valves 301-1 to 301-3 each correspond to valve 301. Valves 301-1 to 301-3 are each located at different points from each other where the liquid being tested is concentrated using each of enrichment columns 200-1 to 200-3. These points can be anywhere on the paths (in the direction of the lines) from the ultrapure water production facility where the liquid to be tested is produced to the point of use where the liquid under test is used and can be remote from each other. Valves 304-1 to 304-3 each correspond to valve 304. Valves 305-1 to 305-3 each correspond to valve 305. Each of containers 501-1 to 501-3 in which eluents 502-1 to 502-3, respectively, are stored corresponds to container 501. Each of filling containers 503-1 to 503-3 corresponds to filling container 503. Each of collection containers 504-1 to 504-3 corresponds to collection container 504. Eluents 502-1 to 502-3 may be pumped from a single container. Collection containers 504-1 to 504-3 may also be a single container.

Controller 702 controls valves 301-1 to 301-3, 304-1 to 304-3, and 305-1 to 305-3 in the same way as controller 700 in the first embodiment. The respective processes in each system, i.e., the enrichment process, purge process, eluent filling process, elution and collection process, and cleaning process, are the same as in the first embodiment. In the third embodiment, controller 702 controls the timing of the enrichment process, purge process, eluent filling process, elution and collection process, and cleaning process in each system.

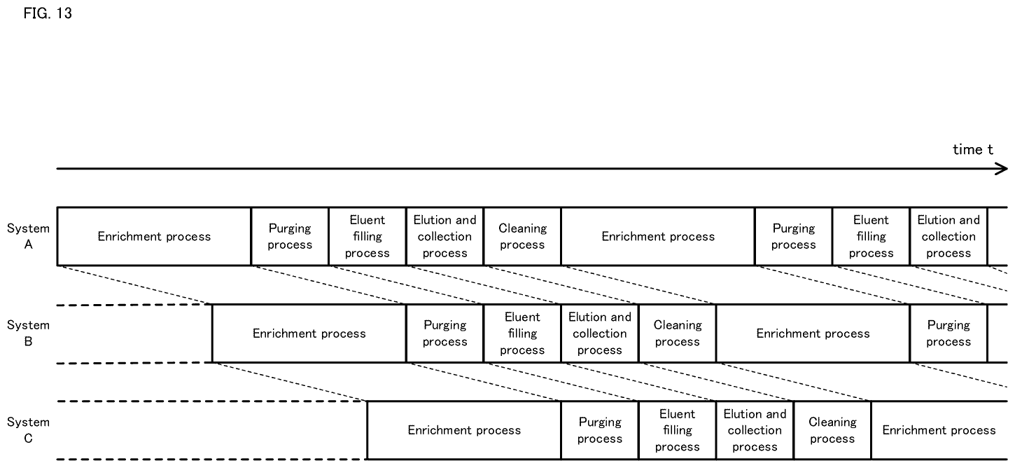

FIG. 13 is a time chart illustrating an example of the intersystem timing control performed by controller 702 shown in FIG. 12. In each of the system equipped with enrichment column 200-1 (hereinafter referred to as system A), the system equipped with enrichment column 200-2 (hereinafter referred to as system B), and the system equipped with enrichment column 200-3 (hereinafter referred to as system C), the enrichment process, purge process, eluent loading process, elution and collection process, and cleaning process are repeated sequentially. Controller 702 controls the timing of the elution and collection process in each system such that the timing of the elution and collection process in that system does not overlap with other systems A, B, and C. Controller 702 controls valves 301-1 to 301-3, 304-1 to 304-3, and 305-1 to 305-3 such that the liquid being tested passes through the enrichment column in at least one of systems A, B, and C. In other words, controller 702 controls the switching of the flow of the liquid being tested supplied from the ultrapure water production facility to enrichment columns 200-1 to 200-3. In this embodiment, the explanation is based on an example having three parallel systems, but the number of systems is not limited to three. Even if collection containers 504-1 to 504-3 are a single container, separate analysis can be performed for each of the enrichment columns by timing the collection at each of the multiple points to differ from each other, as described above. Even if the timing of analysis or other processes overlaps, separate eluent collection is possible by controlling the timing of the elution and collection process by controller 702.

Thus, in this embodiment, multiple systems are established in parallel to analyze the liquid being tested at each of mutually different points, and the timing of the elution and collection process in each system is controlled so that there is no overlap among the systems. In this way, the enrichment process can be performed continuously, and test results can therefore be obtained continuously.

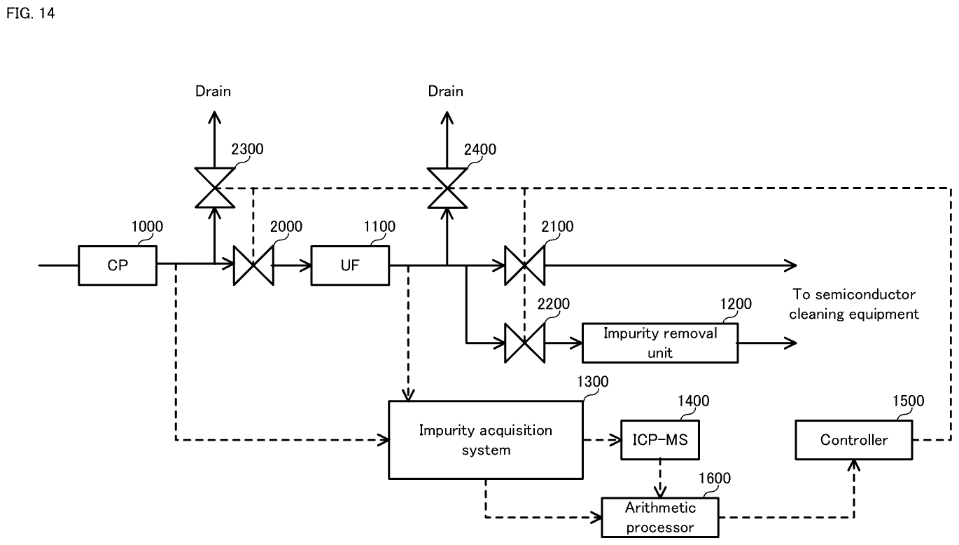

An embodiment that uses the impurity acquisition system described above is next described. FIG. 14 is a diagram showing an example of a liquid production and supply system to which the impurity acquisition system of the present invention is applied. The embodiment shown in FIG. 14 is a system in which ultrapure water is supplied to semiconductor cleaning equipment (point of use) via CP 1000, which is a nonregenerative ion exchange device, and UF 1100, which is an ultrafiltration device, in an ultrapure water production facility. Ultrapure water (water to be tested) supplied to CP 1000 is supplied from a liquid production and supply facility located upstream. Liquid production and supply facilities are also facilities that produce ultrapure water. The dashed lines shown in FIG. 14 indicate paths of water flow or control signals for testing the quality of ultrapure water, which is the liquid to be tested.

There are two flow paths through which ultrapure water is supplied to the semiconductor cleaning equipment. One of the flow paths (systems) includes impurity removal unit 1200, and ultrapure water is thus supplied to the semiconductor cleaning equipment through impurity removal unit 1200. Shutoff valve 2000 is also provided between CP 1000 and UF 1100. Shutoff valve 2300 that controls the flow of water from CP 1000 to the drainage line is also provided. Shutoff valve 2400 that controls the flow of water from UF 1100 to the drainage line is also provided. In addition, shutoff valves 2100 and 2200 are provided in each of the two flow paths for supplying ultrapure water to the semiconductor cleaning system. Water discharged by way of the drainage lines may be collected in tanks provided in the ultrapure water facility as well as in the wastewater treatment facility.

Impurity acquisition system 1300 corresponds to the impurity acquisition system shown in each of FIGS. 1, 9, and 13 and performs the processes described in the first to third embodiments on the ultrapure water from CP 1000 or UF 1100 that is the liquid to be tested. ICP-MS (inductively coupled plasma mass spectrometer) 1400 is a device (information processing device) that detects the amount of impurities in the acquired eluent. Arithmetic processor 1600 is a device that calculates the amount (including concentration) of impurities in the liquid being tested based on the integrated flow rate obtained in the enrichment process by accumulated flow rate meter 411 of impurity acquisition system 1300 and the amount of impurities in the eluate detected by ICP-MS 1400. The quality inspection system consists of impurity acquisition system 1300, ICP-MS 1400, and arithmetic processor 1600. Controller 1500 is a second controller that controls the opening and closing of shutoff valves 2000, 2100, 2200, 2300, and 2400 based on the amount of impurities acquired by the quality inspection system. Controller 1500 may also serve as controllers 700 to 702 described above. No particular limitations apply to the information processing device as long as the device can detect the amount of impurities. The information processing device includes, for example, methods that use an ICP-MS, an ICP-OES (inductively coupled plasma optical emission spectrometer), an atomic absorption spectrophotometer, or an ion chromatography analyzer.

Controller 1500 effects control to close shutoff valve 2000 when the impurity concentration acquired by the quality inspection system for the outlet water of CP 1000 exceeds a preset threshold concentration. At this time, controller 1500 effects control to open shutoff valve 2300. When the impurity concentration acquired by the quality inspection system for the outlet water of CP 1000 is less than or equal to the threshold concentration, controller 1500 effects control to open shutoff valve 2000. At this time, controller 1500 effects control to close shutoff valve 2300. At this time, controller 1500 effects control to close shutoff valve 2300. When the impurity concentration acquired by the quality inspection system for the outlet water of UF 1100 exceeds the preset threshold concentration, controller 1500 effects control to close shutoff valves 2100 and 2200. At this time, controller 1500 effects control to open shutoff valve 2400. When the impurity concentration acquired by the quality inspection system for the outlet water of UF 1100 is less than or equal to the threshold concentration, controller 1500 effects control to open shutoff valves 2100 and 2200. At this time, controller 1500 effects control to close shutoff valve 2400. Controller 1500 may effect control to open shutoff valve 2100 when the impurity concentration acquired by the quality inspection system for the outlet water of UF 1100 is less than or equal to the first threshold concentration. Controller 1500 may effect control such that shutoff valve 2200 opens and shutoff valve 2100 closes when the impurity concentration acquired by the quality inspection system for the outlet water of UF 1100 exceeds the first threshold concentration and is less than or equal to the second threshold concentration. When the impurity concentration acquired by the quality inspection system for the outlet water of UF 1100 exceeds the second threshold concentration, controller 1500 may effect control to close shutoff valves 2100 and 2200. This operation is based on the fact that, even if the flow path in which impurity removal unit 1200 is installed has a somewhat high impurity concentration, the impurities in the ultrapure water will be removed by impurity removal unit 1200 and the impurity concentration of the ultrapure water will therefore be lower when supplied to the semiconductor cleaning equipment.

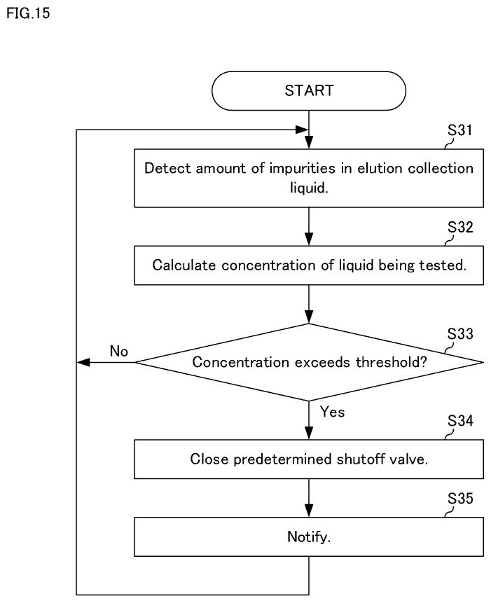

The process in the system shown in FIG. 14 is next described. FIG. 15 is a flowchart illustrating an example of the procedures in the system shown in FIG. 14. An example is next described in which the quality inspection system calculates impurity concentrations for the outlet water of UF 1100 shown in FIG. 14. First, ICP-MS 1400 detects the amount of impurities in the elution collection liquid collected in collection container 504 of impurity acquisition system 1300 for the outlet water of UF 1100 (Step S31). This detection can be achieved by using negative pressure aspiration with ICP-MS 1400 or by a method of using a gas or a pump to transfer liquid and then detecting. Arithmetic processor 1600 then calculates (in Step S32) the concentration in the outlet water of UF 1100 based on the integrated flow rate obtained by accumulated flow rate meter 411 of impurity acquisition system 1300 in the enrichment process and the amount of impurities in the elution collection liquid detected by ICP-MS 1400. Concentration information indicating the calculated concentration is sent from arithmetic processor 1400 to controller 1500. Controller 1500 determines whether the concentration indicated by the transmitted concentration information exceeds the preset threshold concentration (Step S33). When the concentration indicated by the transmitted concentration information exceeds the threshold concentration, controller 1500 closes the prescribed shutoff valves (Step S34). The prescribed shutoff valves are, for example, shutoff valves 2100 and 2200, these being shutoff valves that prevent ultrapure water from the ultrapure water production facility from being supplied to the semiconductor cleaning equipment. At this time, controller 1500 may control shutoff valve 2400 to open and supply ultrapure water to the drainage line. Controller 1500 then notifies the user that the concentration indicated by the transmitted concentration information exceeds the threshold concentration (Step S35). This notification is directed to the administrator or operator of the system or to the manager of the ultrapure water production facility and may be output such as information reporting the relevant data or a display on a screen. Here, as described above, there may be two threshold values to compare with the concentration, and controller 1500 may control the opening and closing of shutoff valves 2100 and 2200 based on the results of comparing the concentration with each of the two threshold values. The specific method of this control was previously described. The same process described above is also used when the quality inspection system calculates impurity concentrations for the outlet water of CP 1000 shown in FIG. 14.

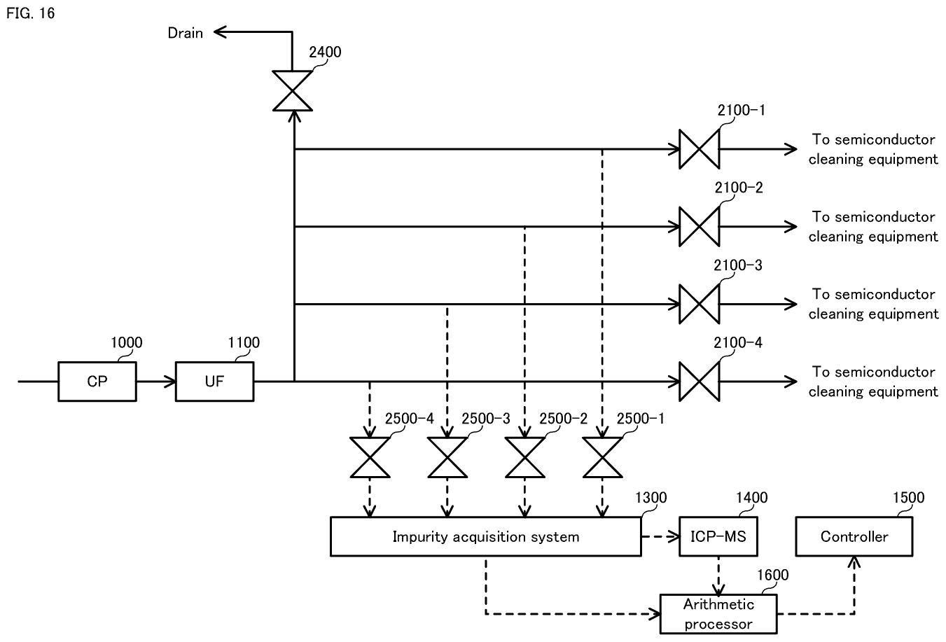

FIG. 16 is a diagram showing another example of a liquid production and supply system to which the impurity acquisition system of the present invention is applied. In the application example shown in FIG. 16, CP 1000, UF 1100, impurity acquisition system 1300, ICP-MS 1400, arithmetic processor 1600, controller 1500, and shutoff valve 2400 are each the same as CP 1000, UF 1100, impurity acquisition system 1300, ICP-MS 1400, arithmetic processor 1600, controller 1500, and shutoff valve 2400, respectively, shown in FIG. 14. Ultrapure water, which is the outlet water of UF 1100, is distributed to multiple flow paths and supplied to multiple semiconductor cleaning devices connected to respective flow paths. Each of the multiple flow paths has a branch flow path to impurity acquisition system 1300, and the ultrapure water flowing in each of the flow paths is processed as described in the first to third embodiments in impurity acquisition system 1300 as the ultrapure water to be tested. Controller 1500 controls the selection of which treatment and which flow path of ultrapure water by opening and closing shutoff valves 2500-1 to 2500-4 on each of the branch flow paths. As in the process described above, controller 1500 also controls the opening and closing of shutoff valves 2100-1 to 2100-4 in the respective flow paths based on the impurity concentrations acquired by the quality inspection system. Controller 1500 has threshold values for each of the multiple semiconductor cleaning devices, and controller 1500 controls the opening and closing of shutoff valves 2100-1 to 2100-4 based on comparisons of the impurity concentrations acquired by the quality inspection system and the threshold values.

Thus, when the concentration of impurities in the ultrapure water exceeds a predetermined threshold concentration, the supply of ultrapure water to the semiconductor cleaning devices is prevented by controlling the shutoff valves. This control prevents contamination of semiconductor production equipment and components in ultrapure water facilities. The liquid (water) that is the object of measurement is not limited to ultrapure water but can also be liquids such as hydrochloric acid, IPA (isopropyl alcohol), PGMA (polyglycerol methacrylate), and PGMEA (propylene glycol monomethyl ether acetate). Although a bottle is used to collect the eluent, the eluent can also be sprayed directly into the analyzer for quantitative analysis. The concentrations of metal impurities to be measured in this impurity acquisition system are not particularly limited, but should be less than 100 ng/L, preferably less than 1 ng/L, and even more preferably less than 0.1 ng/L.

Although the present invention has been described above by allocating each function (process) to a respective component, these assignments are not limited to those described above. In addition, as for the configuration of the components, the above-described embodiments are merely examples, and the present invention is not limited thereto. Further, the present invention may be a combination of the embodiments.

While the present invention has been described with reference to the embodiments, the present invention is not limited to the above embodiments. Various changes can be made in the configuration and details of the present invention within the scope of the present invention that will be understood by those skilled in the art.

This application claims priority based on JP 2022-129978, filed Aug. 17, 2022, and incorporates herein all of the disclosures of that application.

1. An impurity acquisition system for acquiring impurities in a liquid to be tested, comprising:
a first adsorbent that adsorbs impurities in the liquid to be tested; and
a first controller that switches between an enrichment process in which the liquid to be tested is passed through the first adsorbent, an eluent filling process in which a filling container is filled with a predetermined amount of eluent to elute impurities adsorbed on the first adsorbent, and an elution and collection process in which the eluent in the filling container is passed through the first adsorbent and collected in a collection container.

2. The impurity acquisition system according to claim 1, wherein
the first controller performs a purging process to purge the liquid being tested by passing gas through the liquid flow line and the first adsorbent after the enrichment process.

3. The impurity acquisition system according to claim 1, wherein
the first controller, in the elution collection process, passes the eluent in a direction opposite to the direction in which the liquid being tested was passed through the first adsorbent in the enrichment process.

4. The impurity acquisition system according to claim 1, wherein
the first controller performs a cleaning process in which, after the elution and collection process, cleaning liquid is passed through the first adsorbent to clean the first adsorbent.

5. The impurity acquisition system according to claim 4, wherein
the first controller performs the cleaning process as a first cleaning process, then performs a regeneration process in which a regeneration liquid is passed through the first adsorbent to regenerate the first adsorbent, and then performs a second cleaning process in which the cleaning liquid is passed through the first adsorbent.

6. The impurity acquisition system according to claim 5, wherein
the first controller, in the regeneration process, passes the regeneration liquid through the first adsorbent in a direction opposite to the direction in which the liquid being tested was passed in the enrichment process.

7. The impurity acquisition system according to claim 5, wherein
the first controller supplies the liquid being tested to the first adsorbent as cleaning liquid by passing the liquid through a second adsorbent that adsorbs impurities in the liquid being tested in the first and second cleaning processes.

8. The impurity acquisition system according to claim 1, further comprising:
a plurality of acquisition means for acquiring the liquid to be tested from each of a plurality of points on a path from a facility that produces the liquid to be tested to a point of use where the liquid to be tested is used; and
a plurality of the first adsorbents through which the liquid acquired from each of the plurality of points using each of the plurality of acquisition means is respectively passed; wherein
the first controller performs the multiple elution and collection processes for each of the multiple first adsorbents at timings that do not overlap each other.

9. A quality inspection system, comprising:
the impurity acquisition system according to claim 1;
an information processing device that detects the amount of impurities in collected elution liquid that has passed through the first adsorbent; and
an arithmetic processor that calculates the amount of impurities in the liquid being tested.

10. A liquid production and supply system, comprising:
the quality inspection system according to claim 9;
a valve section that controls supply of the liquid to be tested from the liquid production and supply facility that performs at least one of the production and supply of the liquid to be tested to a point of use where the liquid to be tested is used; and
a second controller that controls the valve section based on the amount of impurities in the liquid being tested as calculated by the arithmetic processor.
